(19) United States
(12) Patent Application Publication
(10) Pub. No.: US 2024/0309977 A1
(43) Pub. Date: Sep. 19, 2024

(54) HIGH TEMPERATURE FACE SEALS OF TUBES

(71) Applicant: Honeywell International Inc., Charlotte, NC (US)

(72) Inventors: Mehrad Mehr, Morristown, NJ (US); Robert Mantz, Clifton, NJ (US); Bahram Jadidian, Watchung, NJ (US)

(21) Appl. No.: 18/183,025

(22) Filed: Mar. 13, 2023

(51) Int. Cl. F16L 23/24; F16L 23/036; F16L 23/12; F16L 23/16

(52) U.S. Cl. CPC F16L 23/24; F16L 23/036; F16L 23/12; F16L 23/162

(57) ABSTRACT

An assembly includes a first tube defining a first smooth, planar surface at an end of the first tube. The assembly includes a second tube defining a second smooth, planar surface at an end of the second tube. The assembly includes a force mechanism configured to apply a force to at least one of the first tube or the second tube to maintain contact between the first surface and the second surface. The first surface and the second surface are configured to interface to form a substantially hermetic seal when the assembly is cycled through a temperature cycle. The force is substantially normal to the first and second surfaces.

### GOVERNMENT INTEREST

This invention was made with Government support under 80MSFC21CA010 awarded by NASA. The Government has certain rights in the invention.

### TECHNICAL FIELD

The present disclosure relates generally to high temperature reactor systems, such as systems having at least two different types of pipes or tubes.

### BACKGROUND

Tubes or pipes are used to transport fluids through high-temperature systems such as high temperature reactors. Some systems include different types of tubes, which may include different materials of construction. Joining different types of tubes may be challenging, since the different materials of construction may have different material properties.

### SUMMARY

In general, the disclosure describes systems, such as high-temperature reactor systems, jet or rocket engines, or other similar high temperature systems, which include at least two different types of tubes. The different types of tubes may have different coefficients of thermal expansion (CTE). As such, joining the different types of tubes may be difficult, as their tendency to expand and contract at different rates during temperature changes may lead to fluid leakage through gaps that form between sealing surfaces and/or cracked components. Disclosed herein is a joining assembly which allows tubes having different CTEs to be joined and cycled through time periods of relatively low temperature and relatively high temperature with reduced leaking or fracturing.

An assembly includes a first tube defining a first smooth, planar surface at an end of the first tube. The assembly includes a second tube defining a second smooth, planar surface at an end of the second tube. The assembly includes a force mechanism configured to apply a force to at least one of the first tube or the second tube to maintain contact between the first surface and the second surface. The first surface and the second surface are configured to interface to form a substantially hermetic seal. The force is substantially normal to the first and second surfaces.

Techniques according to the present disclosure include contacting a first smooth, planar surface at an end of a first tube with a second smooth, planar surface at an end of a second tube to form an interface between the first tube and the second tube. The technique also includes applying a force with a force mechanism to at least one of the first or second tube. The force is substantially normal to the first and second surfaces, wherein the force causes a substantially hermetic seal to form between the first surface and the second surface.

The details of one or more examples are set forth in the accompanying drawings and the description below, where like symbols indicate like elements. Other features, objects, and advantages will be apparent from the description and drawings, and from the claims.

### BRIEF DESCRIPTION OF DRAWINGS

FIG. 1 is a conceptual side view illustrating an example first tube and second tube according to some examples the present disclosure, with some internal features illustrated in broken lines.

FIG. 2A is a conceptual bottom view of the first tube of FIG. 1, illustrating an example surface of the example first tube.

FIG. 2B is a conceptual close-up side view illustrating an example smooth, planar surface of the first tube of FIG. 1.

FIG. 3 is a conceptual side view of the first tube and second tube of FIG. 1 and an example force mechanism, with some internal features illustrated in broken lines.

FIG. 4 is a conceptual cross-sectional view taken along a radial plane, illustrating the example first tube, second tube, and force mechanism of FIG. 1 in an assembled state.

FIG. 5 is a flowchart illustrating an example technique according to the present disclosure.

FIG. 6 is a photograph illustrating an example assembly according to some examples of the present disclosure in a disassembled state.

### DETAILED DESCRIPTION

High temperature reactors and other high temperature systems may include tubes for transporting fluids. Such systems may include at least two different types of tubes, such as, for example, a ceramic tube and a metal or metal alloy tube. Ceramic tubes may be used in high temperature systems because they have excellent thermal shock resistance due to a low coefficient of thermal expansion (CTE), the inherent material property that dictates the rate at which a material expands with increase in temperature. Metal or metal alloy tubes may be used on high temperature system for various reasons, including compatibility with low temperature plumbing, allowing for the use of bellow, or other sealing and flow requirements.

Ceramic tubes, such as tubes made of thermal shock resistant ceramic material, may have a low CTE, such as on the order of about 2-6 parts per million per degree Celsius (ppm/° C.). Ceramic materials may therefore be attractive for hot zones that have temperature gradients. Metal or metal alloy tubes may have a higher CTE, such as on the order of 10-17 ppm/° C. Joining tubes with differing CTEs, such as a ceramic tube to a metal tube, may present problems in areas which are exposed to high temperatures and/or temperature swings, because the tubes may expand and contract differently (e.g., different thermal displacements, different rates of expansion or contraction) in response to changes in temperature. The differing displacements and rates of expansion and contraction during temperature cycles may result in deleterious effects, such as cracked tubes or joint components, and/or gaps between sealing surfaces that allow leaks. Fittings for coupling tubes, such as full couplings, half couplings, reducing couplings, compression couplings, and slip couplings, may not work in these applications, because the differing CTEs of the tubes may result in increased displacement between sealing surfaces that creates leaks, increased forces between tubes and/or fittings that creates cracks, increased stress built up in the tubes or fittings, especially after repeated thermal cycles, that creates material fatigue, or other problems associated with a change in forces at an interface between tubes and/or fittings. Some systems try to avoid or minimize the difficulty in joining tubes with different CTEs by using only one type of tube in areas of the system that are subject to high temperatures. However, this solution may use extra material and dedicate extra space, which may be at a premium, to piping systems, or require additional cooling.

Disclosed herein are assemblies, systems, and techniques for joining tubes that having different CTEs that may be space-efficient and/or robust. The disclosed joining assemblies may be useful in high temperature systems such as high temperature reactors (e.g., methane pyrolysis reactors), or other systems which operate in high temperatures or pipe high-temperature fluids. In some examples, these systems may operate above about 315° C., such as above about 425° C. Joining systems according to the present disclosure may allow for joining tubes with different CTEs, such as ceramic tubes and metallic tubes, to be joined in these high-temperature areas, and allow for robust and reliable gas-tight (e.g., gas-tight or nearly gas-tight) sealing performance over a series of cycles between low and high temperatures. Polymeric or elastomeric sealing may not be an option in such high temperature systems, because the high temperature that the system may be configured to operate at would melt or otherwise break down such sealing materials.

Joining assemblies according to the present disclosure are advantageous in high-temperature applications in aerospace, oil and gas, performance materials, and other industries. Ceramic pipes are being integrated into more industrial applications due to their high temperature capabilities, and transitioning ceramic pipes to metal or metal alloy pipes may be an advantageous enabling technology for incorporating high-temperature components into industrial systems.

In some examples, joining assemblies according to the present disclosure may include a first tube and a second tube, each of which define a smooth, planar surface at a respective end. The smooth, planar surfaces of each tube may be contacted and forced together by a force mechanism to form a substantially hermetic seal. Although primarily described as being defined by respective flanges disposed at respective ends of the first tube and second tube, it is also considered that the body of the tube may define the smooth, planar surface, in examples where the tube wall thickness is sufficient to reduce or eliminate paths for fluids contained within the joint to escape the joint. In some examples, the assembly may be configured to accommodate thermal expansion and contraction in an axial direction, a radial direction or both. For example, the first tube may include a section of flexible pipe at an end opposite the first end which defines a smooth, planar surface. Additionally, or alternatively, the force mechanism may be configured to apply a force substantially normal to the first and second smooth, planar surfaces while allowing for radial expansion and contraction of the first and/or the second tube in the area of the joint (e.g., the force mechanism may not contact the first tube or the second tube in the area of the joint.

Although primarily described herein with respect to an example force mechanism which includes a compression assembly, it should be understood that any force mechanism that applies a force substantially normal to the first and/or the second surface to cause them to slide together may be employed. In examples which include a compression assembly, the compression assembly may include a hub that defines a lumen such that the hub may slide freely on the first tube, and a bolt that defines a lumen such that the bolt may slide freely on the second tube. The compression assembly may be configured to compress one or more springs that apply a spring force on the joint to form a hermetic seal. In some examples, the lumen defined by the hub and the lumen defined by the nut may be larger than the outer diameter of their respective tubes, or the flanges on the respective tubes, such that the compression assembly may accommodate radial expansion of the first and/or the second tube in the area of the joint. Thus, a substantially hermetic seal may be formed by the first tube and the second tube, which may be gas-tight and provide an elegant solution for joining tubes with different CTEs.

In some examples, the assembly may be formed by contacting the first smooth, planar surface (“first surface”) of the first tube with the second smooth, planar surface (“second surface”) of the second tube. A force mechanism may apply a force substantially normal to the first and second surfaces to drive the first and second surfaces to interface with contact that is intimate enough to substantially close all flow paths, such that fluid flowing through the joint from the first tube to the second tube or vice versa does not leak out of the joint, even after cycling at relatively high temperature and/or pressure (e.g., at least about 400 degrees Celsius and a pressure of 30 pounds per square inch (psi)). In fact, the disclosed assemblies may operate at very high temperatures, such as greater than about 800 degrees Celsius, or greater than about 1200 degrees Celsius, or up to about 2,000 degrees Celsius, in cases where both the first tube and the second tube include ceramic materials and the force mechanism also includes ceramic materials. In some examples, the disclosed assemblies may be used to join dissimilar ceramic or refractory metal tubes in a hot zone of a high temperature system. In some examples, the disclosed assemblies may be configured to accommodate the differing rates and magnitudes of thermal expansion and contraction of tubes having differing CTEs without breaking the intimate contact between the first and second surfaces, such that the joint remains hermetically sealed throughout the thermal cycle.

The smoothness of the first surface and the second surface may allow for intimate contact between the smooth, planar surfaces at the interface to close any leak paths for in fluid flowing within the first tube and or the second tube to escape the joint at the interface. In some examples, the first surface, the second surface, or both may be optically flat. An optically flat surface may have profile height deviations that deviate, on average, on the order of tens of nanometers from a mean line defined by the surface. Surface roughness, as defined herein, is the average distance that profile height variations deviate from a mean line. However, advantageously, the first and second surfaces need not be optically flat for the seal formed to be substantially hermetic. Rather, in some examples, the first surface, the second surface, or both, may define a surface roughness of less than about 1 micrometer, or from about 1 micrometer to about 5 micrometers. Advantageously, allowing for surface roughness from about 1 micrometer to about 5 micrometers may improve manufacturability of the joints, and allow for the use of such joints in more applications.

In some examples, the first tube comprises a flange at the end of the first tube defining the first surface. The flange may define a radial cross-sectional surface that has greater area than a radial cross-sectional area defined by a body portion of the first tube. For example, an outer perimeter that is larger than an outer perimeter defined by a body of the first tube. Inclusion of a flange at an end of the first tube and/or the second tube which define the respective first and second surfaces may be advantageous because the flange may increase the distance that fluid must flow through a leak path to escape the joint, increasing the chances that a leak path may be closed by intimate contact between the first surface and second surface, even when the first surface and second surface are not optically flat. For example, the surface roughness of the first and second surface may define a plurality of tortuous fluid leak paths beginning at the inner diameter of the tube which fluid can travel in a radial direction from inside the joint towards the outer surroundings of the joint, but the plurality of gas leak paths which fluidically connect an inner lumen passing through the joint to the outer surroundings may be substantially eliminated by inclusion of a flange at the end of the first tube, because most or all of the tortuous leak paths will be closed at some point between the inner lumen and the outer surroundings.

The planarity, which may also be called flatness, of the first and second surfaces may also allow for intimate contact between the first and second surfaces. A perfectly planar surface is straight in two directions. Planarity, in some examples, refers to a maximum distance between two planes defined by the surface. In examples where the first surface and second surface are planar surfaces, intimate contact may be maintained from the inner diameter to the outer diameter of the joint without excessive force from the force mechanism, which may reduce leakage out of the joint. In some examples, the first surface, the second surface or both may define a planarity of less than 20 micrometers, such as less than 10 micrometers, or less than 1 micrometer. Use of planar surfaces, rather than surfaces that are warped (e.g., bowed) may advantageously reduce the force necessary to maintain intimate contact between the first surface and the second surface. Accordingly, the force mechanism may be smaller in physical size, or may apply relatively smaller forces than would be needed to cause non-planar surfaces to intimately contact each other, and thus induce less material stresses in the first tube or the second tube during thermal cycling, or provide other benefits.

The first tube may define a first coefficient of thermal expansion (CTE). For example, the first tube may include a ceramic material, and the first CTE may be from about 2 parts per million per degree Celsius (ppm/° C.) to about 6 ppm/° C. In some examples, the second tube may define a second CTE. For example, the second tube may include a metallic material such as a metal or alloy having a higher CTE than the material of the first tube, such as from about 10 ppm/° C. to about 17 ppm/° C. As such, the second tube may have a different CTE than the first tube, such as at least 4 ppm/° C. different than the first CTE. As the assembly is cycled through different temperatures, the intimate contact necessary to seal fluids flowing through the assembly may be maintained at the interface between the first and second surfaces while the joint may be configured to accommodate radial and/or axial thermal expansion and contraction so that the different CTE materials do not cause either tube to break or fracture.

In some examples, the joining assemblies may be configured to reduce or prevent plastic deformation at the sealing interface to remain gas-tight during continuous or intermittent temperature cycling. Parameters to ensure the assembly forms and holds a seal may include geometric factors (e.g., thickness, diameter, and other geometric ratios), material factors, (e.g., elastic modulus of the materials, yield stress of the materials, temperature dependence of the CTE of the materials), manufacturing parameters, (work hardening during sealing), and other factors that may affect displacement of surfaces or generation of stresses in the joining assemblies. Since the assembly is configured to contain fluids passing through the first and second tubes, tight machining tolerances may also be desirable. Tubes, with or without flanges, of the present disclosure may be manufactured using any suitable technique, including but not limited to subtractive processes such as machining or grinding, additive processes such as additive manufacturing, or mixtures or combinations thereof.

Although described herein primarily with respect to an example assembly joining a ceramic tube to a metal tube, it is considered that assemblies described herein may be useful for other material systems, including assemblies that join two tubes having the same or similar CTEs or that include two materials with different CTEs. For example, two metallic (e.g., metal or metal alloy) tubes could be joined using an assembly in accordance with the present disclosure. In some examples, the metallic tubes could be the same material, and thus have the same CTE. In some examples, the tubes may be constructed of two different types of metals, and thus have different CTEs.

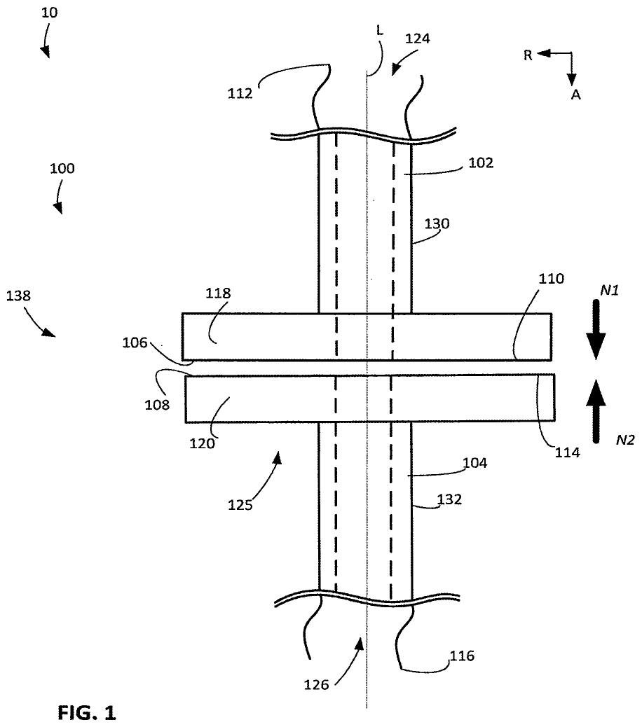

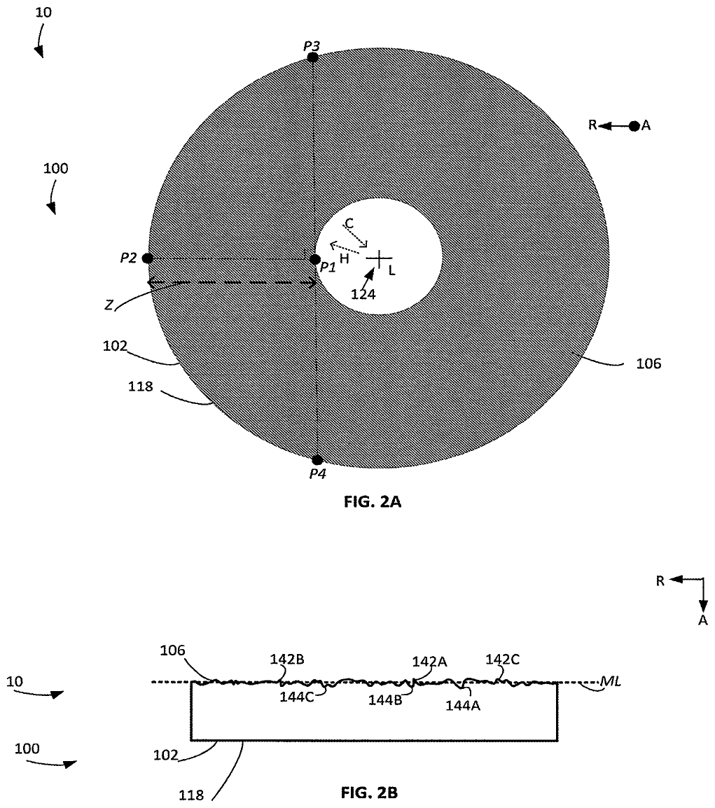

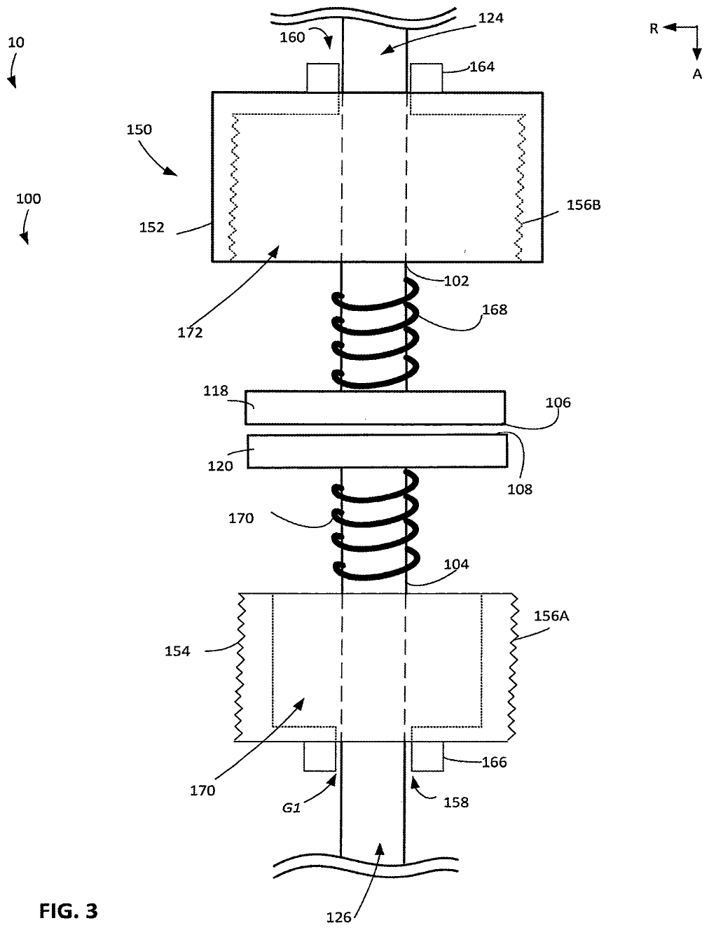

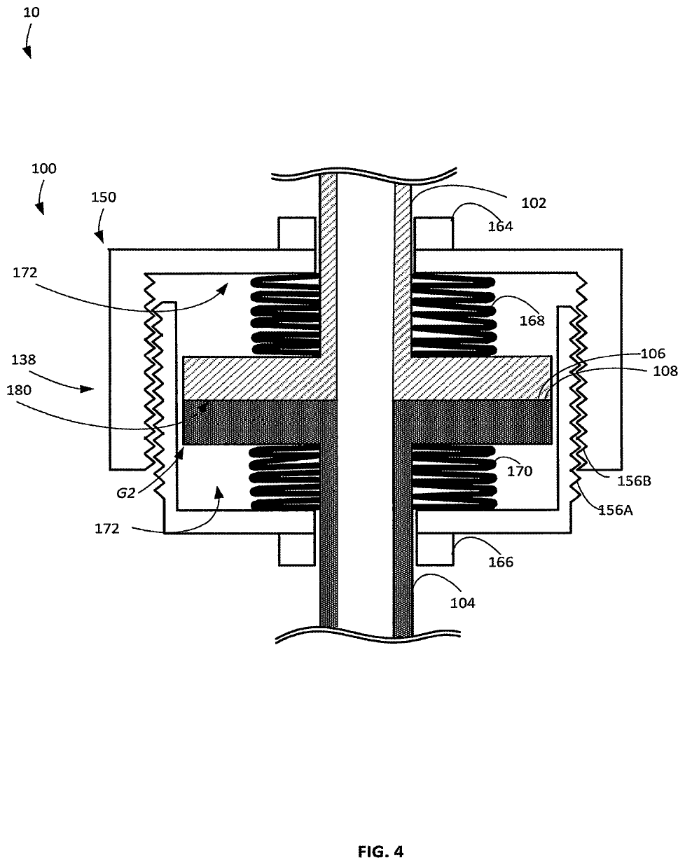

FIGS. 1-4 illustrate example assembly 100 of system 10. FIG. 1 is a conceptual perspective view illustrating example system 10 which includes example assembly 100. Assembly 100 includes a first tube 102 and second tube 104. Some internal features of first tube 102 and second tube 104 are illustrated in broken lines. FIG. 2A is a conceptual cross-sectional view taken along radial plane D extending along radial direction R of FIG. 1, illustrating first surface 106 of first tube 102 of system 10. FIG. 2B is a close-up conceptual side view of a portion of first surface 106. FIG. 3 is a conceptual side view taken of system 10 of FIG. 1 with an example force mechanism 150 added relative to FIG. 1, with force mechanism 150 illustrated in a disengaged state for clarity, with some internal features of force mechanism 150 illustrated in broken lines. FIG. 4 is a conceptual cross-sectional view of system 10 of FIG. 1 illustrated with force mechanism 150 in an engaged state such that contact is maintained between first surface 106 and second surface 108 so that substantially hermetic seal 180 is formed at the interface between first surface 106 and second surface 108. Not all reference numerals are included in each of FIGS. 1-4 for clarity.

With concurrent reference to FIGS. 1-4, assembly 100 includes first tube 102 and second tube 104. Each of first tube 102 and second tube 104 is configured to transport fluids within system 10 and constructed from materials suitable for containing fluids. In some examples, the fluids may be hot gases, which may be under pressure. First tube 102 defines central lumen 124 extending along an axial length of first tube 102 from first end of the first tube 110 to second end of first tube 112, such that fluids may be transported from any part of system 10, through first tube 102 and into second tube 104. Second tube 104 defines central lumen 126 extending axially along an axial length of second tube 104 from first end of second tube 114 to second end of second tube 116, such that fluids may be transported from any part of system 10, through second tube 104 and into first tube 102, or vice versa. Together, first tube central lumen 124 and second tube central lumen 126 may define inner lumen 125, which may fluidically connect first tube 102 and second tube 104 through joint 138. Although illustrated as linear in axial direction A, in some examples first tube 102 and/or second tube 104 may be curved or include one or more segments disposed angularly from one another. In some examples, as illustrated, central axial axis L may be shared by first tube 102 and second tube 104.

First tube 102 and second tube 104 are configured to interface with each other to form a joint 138. First tube 102 includes first tube flange 118 which defines first surface 106. First surface 106 is configured to contact second surface 108 of second tube flange 120 of second tube 104. Contact is maintained between first surface 106 and second surface 108 during temperature cycling of system 10 such that no or only minimal fluid escapes from or into joint 138. Flanges 118 and 120 are sections of first tube 102 and second tube 104 respectively at respective ends 110, 114. Flanges 118 and 120 each define a larger perimeter than the respective body portions 130, 132 of first tube 102, 104. Thus, respective flanges 118, 120 may increase the surface area for contact between tubes 102 and 104 relative to tubes which do not define flanges at their interfacing ends, and may thus reduce or eliminate leakage out of joint 138. Although the illustrated example shows flanges 118, 120 extending radially outside the outside diameter of tubes 102, 104, the flanges 118, 120 may additionally or alternatively extend radially into central lumen 125 relative to body portions 130, 132. Furthermore, although illustrated as matching in size in the radial direction, in some examples one the flanges 118, 120 may be larger than the other one in radial direction R, and/or one of the tube body portions 130, 132 may be larger than the other one in radial direction R.

Flanges 118 and 120 may have any suitable thickness (axial dimension along arrow A). The thickness of one or both flanges may be adapted to receive a force from force mechanism 150 (FIGS. 3 and 4) without cracking or breaking. In some examples, one or both of flanges 118, 120 may define a perimeter from about 1.5 to about five times as large as the perimeter or respective body portions 130, 132. In some examples, one or both flanges may define a thickness in the axial direction of from about 0.5 to about two times their respective tube diameter. Sizing one or both flanges 118, 120 in these ranges may assist in forming substantially hermetic seal 180 at joint 138 without an unnecessarily large physical footprint. Accordingly, assembly 100 may be applicable in more small, cramped applications.

While first tube 102 and second tube 104 may both be configured to contain gases, first tube 102 and second tube 104 may be formed from different materials that may be particularly suited for different functions. For example, first tube 102 may be configured to direct gases into a reactor or other high temperature system, while second tube 104 may be configured to interface with lower temperature tubing. As a result of these different materials, the CTE of second tube 104 may be different than the CTE of first tube 102. Additionally, first tube 102 and second tube 104 may contain gases that fluctuate in temperature based on the operating status and/or conditions of the high temperature system that result in temperature cycles.

First tube 102 and second tube 104 are configured to form seal 180 at joint 138 when a force mechanism applies a force substantially normal to first surface 106 and second surface 108 that causes first surface 106 and second surface 108 to come into and/or maintain contact. Forces normal to the surfaces 106, 108 are illustrated by arrows N1 and N2 in FIG. 1. Substantially normal, as defined herein, include a force that is perpendicular to a surface or within 30 degrees of perpendicular to the surface. Unlike Marman clamps, ring clamps, band clamps, and the like, which may apply a force or forces at the joint in a substantially perpendicular direction to first surface 106, force mechanism 150 may maintain hermetic seal 18 while allowing for expansion and contraction of joint 138.

Seal 180 is illustrated in FIG. 4, which will be described in more detail below. Seal 180 is formed by intimate contact between first surface 106 and second surface 108 during these temperature cycles (e.g., an on/off cycle of a high temperature cycle). The coefficient of thermal expansion of first tube 102 is different from the CTE second tube 104. For example, the difference in the CTE of second tube 104 and first tube 102 may be greater than 4 ppm/° C. Assembly 100 may be a joining solution for tubes with CTE differences, because the relationship between first surface 106 and second surface 108 may be maintained.

In some examples, as illustrated, first surface 106 and second surface 108 may be substantially perpendicular (e.g., perpendicular or nearly perpendicular, such as within 5 degrees) to central axial axis L. Alternatively, in some examples, first surface 106 and second surface 108 may interface at another angle relative to central axial axis L, such as at a 45-degree angle.

In the illustrated example, first tube 102 includes a ceramic material, and second tube 104 comprises a metallic material. Alternatively, in some examples, first tube 102 may include a metallic material, and second tube 104 may also include a metallic material. In further examples, first tube 102 may include a ceramic material, and second tube 104 may also include a ceramic material 104. In some examples, first tube 102 may include a ceramic material. In some examples, the ceramic material may be selected from the group consisting of carbon, carbon-carbon composites, graphite, MACOR®, available from Corning, Inc. (Corning, NY, USA), silicon carbide, silicon carbide/silicon carbide composites, oxide/oxide composites, alumina, zirconia, silicon nitrides, other ceramics, or mixtures or combinations thereof. In some examples, second tube 104 includes a metallic material. Metallic materials may include any suitable metal or metal alloy. In some examples, the metallic material of first tube 102 may have a lower CTE than the metallic material of second tube 104. In examples where first tube 102 may include a low CTE metallic material, the low CTE metallic material may include a refractory metal. Suitable refractory metals include, but are not limited to, molybdenum, tungsten, niobium, tantalum, rhenium, or the like.

FIGS. 2A and 2B illustrate example first surface 106 of first tube 102. FIG. 2A illustrate first tube 102 looking up from the bottom of the page in FIG. 1. Although described as first surface 106, the description may also apply to second surface 108, since both first surface 106 and second surface 108 have smooth, planar surface finishes configured to maintain intimate contact with each other.

Since first surface 106 and second surface 108 are configured to maintain intimate contact throughout thermal cycling, and since first tube 102 and second tube 106 may include materials having a different CTE, assembly 100 may be configured to accommodate thermal expansion and contraction of assembly 100 during temperature cycling. FIG. 2A includes arrows C and H, which illustrate the direction of thermal contraction and expansion forces on assembly 100 during periods of cooling and heating, respectively. In some examples, during periods of cooling, first tube 102 may contract toward axis L, the central axial axis of assembly 100. Similarly, arrow H illustrates the direction of thermal expansion forces during periods of heating. Periods of increasing temperature may cause first tube 102 and second tube 104 to expand according to the CTE of their material(s) of construction, while periods of decreasing temperature may cause first tube 102 and second tube 104 to contract according to the CTE of their material(s) of construction.

A thermal cycle may include a heating period, where assembly 100 expands in a direction along arrow H in a direction away from central axial axis L, and a cooling period, where assembly 100 contracts in a direction along arrow C towards central axial axis L. Seal 180 at joint 138 may be configured to be substantially gas tight through a series of thermal cycles, because the expansion and contraction of tubes 102, 104 with different CTEs may be accommodated while intimate contact between first surface 106 and second surface 108 is maintained.

Surface 106 may define a planarity. For example, a point P1 on surface 106 at the inner diameter of first tube 102 and a point P2 at the outer diameter of first tube 102 may define a first line. Point P3 and point P4 may be points on surface 106 at the outer diameter of first tube 102 that define a second line that is perpendicular to the first line. On a perfectly planar surface, all of points P1, P2, P3, and P4 lie on the same plane, which may be the case in examples where surface 106 is perfectly planar. However, in some examples, surface 106 may not be perfectly planar. The deviation of surface 106 from a perfectly planar surface may be measured as the surface's planarity. For example, points P1. P2, and P3 may define a first plane, and points P1, P2, and P4 may define a second plane.

The planarity of surface 106 may be defined as the distance (into and out of the page) between the first plane and the second plane at point P3 or point P4. In some examples, first surface 106, second surface 108, or both may define a planarity of less than about 100 micrometers, such as less than about 50 micrometers, less than about 20 micrometers, or less than about 10 micrometers. “About,” as defined herein, encompasses values within the stated value or range plus or minus 10%. In other examples, the planarity of surface 106 may be defined as the slope of the second plane relative to the first plane along the second line between point P3 and P4. In some examples, the slope of the second plane relative to the first plane may be less than about 250 micrometers per centimeter, or less than about 100 micrometers per centimeter, or less than about 20 micrometers per centimeter, or less than about 10 micrometers per centimeter.

FIG. 2B illustrates a magnified portion of surface 106 from a side view. Surface 106 may be a smooth surface, which may be characterized by a relatively low surface roughness. Surface 106 defines mean line ML, which may be determined by a regression analysis using a least squares method, or with another method. In any case, mean line ML is a statistically defined line defined by surface 106 across a sampling distance. In some examples, the sampling distance may be distance Z (FIG. 2A) between points P1 and P2 described above. Surface 106 may include a plurality of peaks 142A, 142B, 142C (collectively “peaks 142”), which are points of local extremity extending above mean line ML. Similarly, surface 106 may include a plurality of valleys 144A, 144B, 144C (collectively “valleys 142”), which are points of local extremity extending below mean line ML.

In some examples, surface roughness may be defined as a maximum surface roughness, which is the maximum distance between a highest peak 142A and a deepest valley 144A. In some examples, surface 106 may be an optically flat surface, which may have a maximum surface roughness on less than about 1 micrometer. However, in some examples, surface 106 may define a maximum surface roughness of less than about 15 micrometers, or less than about 5 micrometers, or between about 1 micrometer and about 5 micrometers.

In some examples, the surface roughness of surface 106 may be characterized by the average surface roughness, Ra. The Ra of a surface may be defined as the average distance from surface 106 to mean line ML across surface 106 (e.g., from left to right in FIG. 2B). In some examples, the Ra of surface 106 may be less than about 10 micrometers, or less than about 8 micrometers, or less than about 5 micrometers, or less than about 1 micrometer.

FIGS. 3 and 4 illustrate assembly 100 with force mechanism 150 added relative to the previous figures. Force mechanism 150 includes a compression assembly, which is configured to apply forces N1 and N2 of FIG. 1. FIG. 3 illustrates force mechanism 150 in a disengaged state, where forces N1 and N2 of FIG. 1. are not being applied, while FIG. 4 illustrates force mechanism 150 in an engaged state, where forces N1 and N2 are being applied by force mechanism 150.

FIG. 3 is a conceptual side view, where internal features of hub 152 and bolt 154 of the compression assembly of force mechanism 150 are illustrated in dashed lines. FIG. 4 is a conceptual cross-sectional view along central axial axis L (FIG. 1). Force mechanism 150 further includes first spring 168 surrounding first tube 102 and second spring 170 surrounding second tube 104.

With concurrent reference to FIGS. 3 and 4, hub 152 and bolt 154 make up the compression assembly of force mechanism 150. Hub 150 defines lumen 160 and is configured to slide onto and freely along first tube 102. Similarly, bolt 154 defines lumen 158 and is configured to slide onto and freely along second tube 104. In some examples, lumen 158, lumen 160, or both may be larger in diameter than respective tubes 102, 104, such that radial expansion of the tubes is accommodated by gap G1.

Bolt 154 may also define bolt recess 172. Bolt recess 172 may be a void volume within bolt 154 with a wider diameter than first flange 118 and/or second flange 130 such that bolt 154 may slide axially to engage hub 152, and may accommodate radial expansion of flanges 118, 130 by gap G2. In some examples bolt 154 may define outer threads 156A, and hub 152 may define inner threads 156B (collectively “threads 156”) Threads 156 may be configured to engage each other, such that bolt 154 threads into hub recess 174 of hub 152. In some examples, hub 152 may include nut 164, and bolt 154 may include nut 158, such that nuts 164 and/or 166 may be engaged by tooling to engage the threadable bellows.

Springs 168, 170 are illustrated in their respective default positions in FIG. 3, and in their respective compressed state in FIG. 4. As threads 156 progressively engage each other from the disengaged stat (FIG. 3) to the engaged state (FIG. 4), each respective spring 168, 170 may become more compressed, and each spring may applying a spring expansion force according to Hooke's law. Since threads 156 may prevent hub 152 and bolt 154 from displacing from each other in axial direction A, first spring 168 may be caused to apply force N1 (FIG. 1) and second spring 170 may apply force N2 (FIG. 1). Advantageously, this example force mechanism 150 allows for tailoring of the forces substantially normal to the surface because threads 156 may be more or less engaged depending on the desired amount of force. Although described and discussed thus far as including two springs 168, 170 and applying both forces N2 and N2, it is considered that some example assemblies may include only first spring 168 or second spring 170, and thus only apply one of forces N1 or N2 (FIG. 1). In some examples, only one of these forces may be sufficient to cause first surface 106 and second surface 108 to form and maintain seal 180 at joint 138.

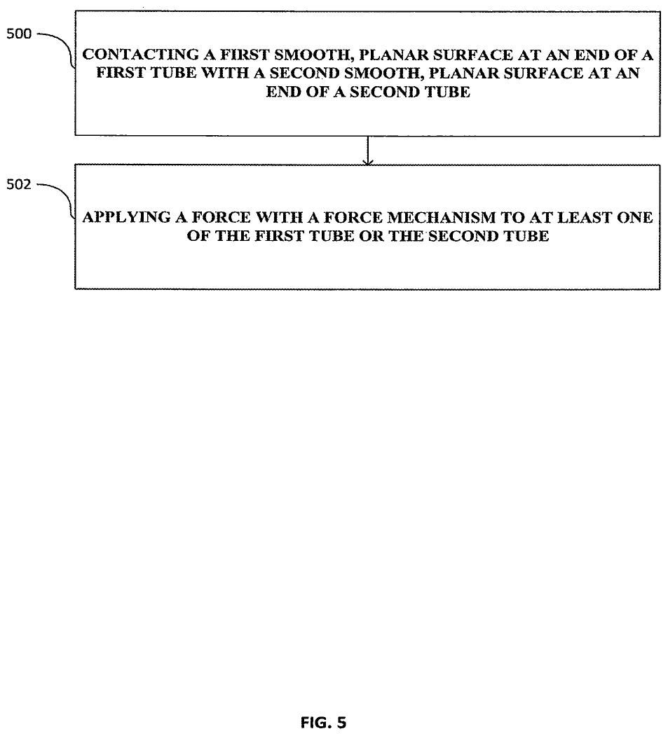

FIG. 5 is a flowchart illustrating an example technique for forming a seal assembly. Although the technique of FIG. 5 is described with reference to assembly 100 of FIGS. 1-4, the technique of FIG. 5 may be performed with another assembly, and assembly 100 may be used to perform other techniques.

The technique of FIG. 5 includes contacting first smooth, planar surface 106 at first end 110 of first tube 102 with second smooth, planar surface 108 at first end 114 of second tube 104 to form an interface between first tube 102 and second tube 104 (500). In some examples, a coefficient of thermal expansion (CTE) of first tube 102 may be substantially different from the CTE of second tube 104. For example, the CTE of first tube 102 may be at least 1 parts per million per degree Celsius (ppm/° C.) different than the CTE of second tube 104, or at least about 2 ppm/° C., or at least about 4 ppm/° C.

The technique of FIG. 5 also includes applying a force N1, N2, or both with force mechanism 150 to at least one of first tube 102 or second tube 104 (502). In some examples, force N1, N2, or both may be substantially normal to first surface 106 and second surface 108. Force N1, N2, or both may cause a substantially hermetic seal 180 to form between first surface 106 and second surface 108 at joint 138. A substantially hermetic seal 180 may be a seal that does not substantially allow leakage of gases at the operating conditions anticipated for the particular system, such as leakage below an amount detectable by conventional detection equipment for the particular system.

In some examples, first tube 102 may include a flange 118 at first end 110, and flange 118 may define first surface 106. The outer perimeter (e.g., radial outer diameter) of flange 118 may by larger than the outer perimeter (e.g., radial outer diameter) of first tube body portion 130. first tube 102 may include a ceramic material, and second tube 104 may include a metallic material. As used herein, the terms “first” and “second” are merely intended to distinguish similar elements and do not imply any particular relationship between elements labeled as the “first” and “second.”

With concurrent reference to FIG. 2B and FIG. 5, in some examples, each of first surface 106 and second surface 108 may define a roughness. The surface roughness may be defined as a maximum surface roughness, which may be the maximum distance between highest peak 142A and deepest valley 144A. In some examples, first surface 106 and/or second surface 108 may be an optically flat surface, which may have a maximum surface roughness on less than about 1 micrometer. However, in some examples, first surface 106 and/or second surface 108 and may define a maximum surface roughness of less than about 15 micrometers, or less than about 5 micrometers, or between about 1 micrometer and about 5 micrometers.

In some examples, the surface roughness of first surface 106 and or second surface 108 may be characterized by the average surface roughness, Ra. The Ra may be defined as the average distance from surface 106 to mean line ML across surface 106 (e.g., from left to right in FIG. 2B). In some examples, the Ra of surface 106 may be less than about 10 micrometers, or less than about 8 micrometers, or less than about 5 micrometers, or between about 1 micrometer and about 5 micrometers.

With concurrent reference to FIGS. 2A and 5, the planarity of first surface 106 may be defined as the distance between the first plane and the second plane at point P3 or point P4. In some examples, first surface 106, second surface 108, or both may define a planarity of less than about 100 micrometers, such as less than about 50 micrometers, less than about 20 micrometers, or less than about 10 micrometers. In other examples, the planarity of first surface 106 and/or second surface 108 may be defined as the slope of the second plane relative to the first plane along the second line between point P3 and P4. In some examples, the slope of the second plane relative to the first plane may be less than about 250 micrometers per centimeter, or less than about 100 micrometers per centimeter, or less than about 20 micrometers per centimeter, or less than about 10 micrometers per centimeter.

In some examples, applying force N1, N2, or both with a force mechanism may include applying a spring force (FIG. 4) from one or more springs 168, 170. In some examples, applying force N1, N2, or both with force mechanism may include threading a compression assembly such that bolt 154 engages and is received by hub 152.

In some examples, the technique of FIG. 5 may include forming, at second end 112 of first tube 102, second end 116 of second tube 104, or both, a mechanism configured to accommodate axial or radial expansion and contraction of first tube 102, second tube 104, or both. In some examples, the mechanism may be a section of flexible pipe. In some examples, first tube 102, second tube 104, or both may define central axial axis L, and first surface 106 may be substantially perpendicular to the central axial axis L when assembly 100 is an engaged state (FIG. 4). Other arrangements are considered, such as where first surface 106 forms a 45 degree angle with central axial axis L.

### Examples

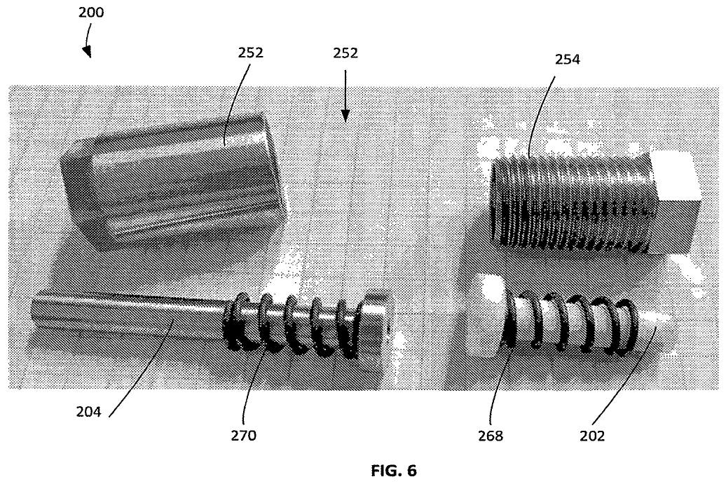

FIG. 6 illustrates example assembly 200, which may be generally described similarly to assembly 100 of FIG. 1, where similar reference numerals indicate similar elements. Example seal assembly 200 of FIG. 6 was and tested. MACOR® was the ceramic material used to make first tube 202, and stainless-steel alloy 304 was used to make second tube 204. Force mechanism 250 included a first spring 268 and second spring 270 which included steel.

The difference between the CTEs of the ceramic MACOR® of first tube 202 and the metallic stainless-steel alloy of second tube 204 was about 6 ppm/° C. The assembly was thermally cycled by placing the assembly in an oven at a temperature 427° C. for 10 minutes, followed by 10 minutes at room temperature. After 2000 cycles, hermeticity testing was conducted during which pressurized gas was contained within the assembly. No leakage was observed at 20 psi, or at 30 psi. At 55 psi, a slight leakage at a rate of 0.11 standard cubic centimeters per minute was observed and calculated by optical imaging and the rate of bubbles generated. This leak rate was lower than can be accurately measured with a conventional flowmeter. The joint showed successful sealing and no damage after 150 cycles of heating and cooling down. In the tested example, steel springs 268, 270 began to creep due to the high temperature. A high-temperature spring including one or more of a nickel-chromium alloy, a titanium-zirconium-molybdenum alloy, an alloy including tungsten, a graphite, a ceramic, a carbon/carbon composite, a silicon carbide/silicon carbide component, a refractory metal, or the like may address this failure mode, and allow for even high temperature and/or pressure operations. Additionally, it is expected that including hub 252 and bolt 254 which include such materials may allow the example assembly to form a seal that may be thermally cycled at temperatures up to about 800 degrees Celsius, or up to about 1200 degrees Celsius, or up to about 2,000 degrees Celsius.

The following clauses illustrate example subject matter described herein.

Clause 1: An assembly includes a first tube defining a first smooth, planar surface at an end of the first tube; a second tube defining a second smooth, planar surface at an end of the second tube; a force mechanism configured to apply a force to at least one of the first tube or the second tube to maintain contact between the first surface and the second surface; wherein the first surface and the second surface are configured to interface to form a substantially hermetic seal, wherein the force is substantially normal to the first and second surfaces.

Clause 2: The assembly of clause 1, wherein a coefficient of thermal expansion (CTE) of the first tube is substantially different from a CTE of the second tube.

Clause 3: The assembly of clause 1, wherein the first tube comprises a flange at the end of the first tube defining the smooth, planar surface, and wherein the flange defines a radial cross-sectional surface that has greater area than a radial cross-sectional area defined by a body portion of the first tube.

Clause 4: The assembly of clause 1, wherein the first tube comprises a ceramic material, and wherein the second tube comprises a metallic material.

Clause 5: The assembly of clause 1, wherein each of the first surface and the second surface define a roughness, and wherein the roughness of each of the first surface and the second surface is from about 1 micron to about 5 microns.

Clause 6: The assembly of clause 1, wherein each of the first surface and the second surface define a planarity than is less than about 20 microns.

Clause 7: The assembly of clause 1, wherein the assembly is configured to be part of a high-temperature reactor.

Clause 8: The assembly of clause 1, wherein the assembly is configured to form a substantially hermetic seal after thermal cycling to a temperature of 400 degrees Celsius and a pressure of 30 pounds per square inch (psi).

Clause 9: The assembly of clause 1, wherein the force mechanism comprises a spring configured to apply a spring force to form the substantially hermetic seal between the first surface and the second surface.

Clause 10: The assembly of clause 8, wherein the spring is a high-temperature spring comprising one or more of a nickel-chromium alloy, a titanium-zirconium-molybdenum alloy, an alloy including tungsten, a carbon/carbon composite, a silicon carbide/silicon carbide composite, or the like.

Clause 11: The assembly of clause 1, wherein the force mechanism comprises a compression assembly which includes a bolt and a hub.

Clause 12: The assembly of clause 1, wherein the first tube defines a central axial axis, and wherein the first surface is substantially perpendicular to the central axial axis.

Clause 13: The assembly of clause 1, wherein an end of the first tube opposite the first smooth, planar surface is configured to accommodate axial expansion and contraction of the first tube.

Clause 14: The assembly of clause 1, wherein the CTE of the first tube is at least 4 parts per million per degree Celsius ppm/° C. different than the CTE of the second tube.

Clause 15: The assembly of clause 1, wherein the force mechanism is configured to accommodate radial expansion and contraction of the first tube or the second tube.

Clause 16: A method includes contacting a first smooth, planar surface at an end of a first tube with a second smooth, planar surface at an end of a second tube to form an interface between the first tube and the second tube; and applying a force with a force mechanism to at least one of the first tube or the second tube, wherein the force is normal to the first surface and the second surface, wherein the force causes a substantially hermetic seal to form between the first surface and the second surface.

Clause 17: The method of clause 16, wherein a coefficient of thermal expansion (CTE) of the first tube is substantially different from a CTE of the second tube.

Clause 18: The method of clause 16, wherein the first tube comprises a flange at the end of the first tube defining the smooth, planar surface, and wherein the flange defines a radial cross-sectional surface that has greater area than a radial cross-sectional area defined by a body portion of the first tube.

Clause 19: The method of clause 16, wherein the first tube comprises a ceramic material, and wherein the second tube comprises a metallic material.

Clause 20: The method of clause 16, wherein each of the first surface and the second surface define a roughness, and wherein the roughness of each of the first surface and the second surface is from about 1 micron to about 5 microns.

Clause 21: The method of clause 16, wherein each of the first surface and the second surface define a planarity that is less than about 20 microns.

Clause 22: The method of clause 16, further comprising forming a high-temperature reactor including the first tube.

Clause 23: The method of clause 16, wherein applying the force with the force mechanism comprises applying a spring force.

Clause 24: The method of clause 16, wherein applying the force with the force mechanism comprises threading a compression assembly which includes a hub and a bolt.

Clause 25: The method of clause 16, wherein the first tube defines a central axial axis, and wherein the first surface is substantially perpendicular to the central axial axis.

Clause 26: The method of clause 16, wherein an end of the first tube opposite the first smooth, planar surface is configured to accommodate axial expansion and contraction of the first tube.

Clause 27: The method of clause 16, wherein the CTE of the first tube is at least 1 parts per million per degree Celsius ppm/° C. different than the CTE of the second tube.

Clause 28: The method of clause 16, wherein the force mechanism is configured to accommodate radial expansion and contraction of the first tube or the second tube.

What is claimed is:

1. An assembly comprising:
a first tube defining a first smooth, planar surface at an end of the first tube;
a second tube defining a second smooth, planar surface at an end of the second tube;
a force mechanism configured to apply a force to at least one of the first tube or the second tube to maintain contact between the first surface and the second surface; wherein the first surface and the second surface are configured to interface to form a substantially hermetic seal,
wherein the force is substantially normal to the first and second surfaces.

2. The assembly of claim 1, wherein a coefficient of thermal expansion (CTE) of the first tube is substantially different from a CTE of the second tube.

3. The assembly of claim 1,
wherein the first tube comprises a flange at the end of the first tube defining the smooth, planar surface, and
wherein the flange defines a radial cross-sectional surface that has greater area than a radial cross-sectional area defined by a body portion of the first tube.

4. The assembly of claim 1, wherein the first tube comprises a ceramic material, and wherein the second tube comprises a metallic material.

5. The assembly of claim 1, wherein each of the first surface and the second surface define a roughness, and wherein the roughness of each of the first surface and the second surface is from about 1 micron to about 5 microns.

6. The assembly of claim 1, wherein each of the first surface and the second surface define a planarity than is less than about 20 microns.

7. The assembly of claim 1, wherein the assembly is configured to be part of a high-temperature reactor.

8. The assembly of claim 1, wherein the assembly is configured to form a substantially hermetic seal after thermal cycling to a temperature of 400 degrees Celsius and a pressure of 30 pounds per square inch (psi).

9. The assembly of claim 1, wherein the force mechanism comprises a spring configured to apply a spring force to form the substantially hermetic seal between the first surface and the second surface.

10. The assembly of claim 8, wherein the spring is a high-temperature spring comprising one or more of a nickel-chromium alloy, a titanium-zirconium-molybdenum alloy, an alloy including tungsten, a carbon/carbon composite, a silicon carbide/silicon carbide composite, or the like.

11. The assembly of claim 1, wherein the force mechanism comprises a compression assembly which includes a bolt and a hub.

12. The assembly of claim 1, wherein the first tube defines a central axial axis, and wherein the first surface is substantially perpendicular to the central axial axis.

13. The assembly of claim 1, wherein an end of the first tube opposite the first smooth, planar surface is configured to accommodate axial expansion and contraction of the first tube.

14. The assembly of claim 1, wherein the CTE of the first tube is at least 4 parts per million per degree Celsius ppm/° C. different than the CTE of the second tube.

15. The assembly of claim 1, wherein the force mechanism is configured to accommodate radial expansion and contraction of the first tube or the second tube.

16. A method comprising:
contacting a first smooth, planar surface at an end of a first tube with a second smooth, planar surface at an end of a second tube to form an interface between the first tube and the second tube; and
applying a force with a force mechanism to at least one of the first tube or the second tube, wherein the force is normal to the first surface and the second surface, wherein the force causes a substantially hermetic seal to form between the first surface and the second surface.

17. The method of claim 16, wherein a coefficient of thermal expansion (CTE) of the first tube is substantially different from a CTE of the second tube.

18. The method of claim 16,
wherein the first tube comprises a flange at the end of the first tube defining the smooth, planar surface, and
wherein the flange defines a radial cross-sectional surface that has greater area than a radial cross-sectional area defined by a body portion of the first tube.

19. The method of claim 16, wherein the first tube comprises a ceramic material, and wherein the second tube comprises a metallic material.

20. The method of claim 16, wherein each of the first surface and the second surface define a roughness, and wherein the roughness of each of the first surface and the second surface is from about 1 micron to about 5 microns.
